(19) United States
(12) Patent Application Publication
(10) Pub. No.: US 2024/0072686 A1
(43) Pub. Date: Feb. 29, 2024

(54) Cigarette Filter Triboelectric Nanogenerator and the Manufacturing Method for the Same

(71) Applicant: National Taiwan University of Science and Technology, Taipei (TW)

(72) Inventors: Chang-Mou Wu, Xiluo Township (TW); Mohana Rani Gokana, Taipei (TW)

(21) Appl. No.: 17/960,992

(22) Filed: Oct. 6, 2022

(30) Foreign Application Priority Data
Aug. 25, 2022 (TW) 111132129

(51) Int. Cl. H02N 1/04; B09B 3/35; B09B 3/40; B09B 3/70; B82Y 30/00; H02J 7/34

(52) U.S. Cl. CPC H02N 1/04; B09B 3/35; B09B 3/40; B09B 3/70; B82Y 30/00; H02J 7/345; B09B 2101/25

(57) ABSTRACT

A cigarette filter-triboelectric nanogenerator (CF-TENG) which generates triboelectric power. The cigarette filter-triboelectric nanogenerator (GF-TENG) includes a positive triboelectric material made from recycled cigarette filters (CFs) and a negative triboelectric material made from plastic waste, wherein the cigarette filters were mixed with conductive materials. The cigarette-filter triboelectric nanogenerator (CF-TENG) device exhibits excellent electrical output performance.

### FIELD OF INVENTION

The present invention relates to a nanogenerator, and particularly to a triboelectric nanogenerator and a manufacturing method for the same.

### BACKGROUND OF THE INVENTION

Discarded cigarette filters (CFs) are the main form of waste that cause severe environmental pollution hazards. CFs contain non-biodegradable cellulose acetate and hazardous materials that can be released into water and cause health problems in living organisms. CF has properties similar to plastics when directly discarded into the environment. According to recent findings, plastic litters and waste accumulations are dangerous to living organisms and even cause death of many marine lives and sea birds. Meanwhile, with the depletion of fossil fuels, rapid population growth, and industrialization, energy crisis has already been a key problem globally. To solve this issue, various organizations, such as the United States Environmental Protection Agency (USEPA) and Energy Information Administration (EIA), are focusing on executing the waste-to-energy concept to effectively generate electricity and fuel from waste materials for the generation of renewable and green energy. In this concept, recycling of waste materials plays a crucial role in two ways. First, during the recycling of waste materials, waste materials are eliminated from the environment and create a clean and safe environment. Second, green and renewable energy can be generated using recycled waste materials, enabling the resolution of the global issue of energy shortage. Thus, the waste-to-energy strategy is a noble proposal from environmental and economic perspectives, and the design and selection of suitable materials for this purpose are very important.

According to recent discoveries, nanogenerators (NG) is capable of collecting electricity from low frequency vibrations under some environmental conditions, and can be applied to electric appliances and battery-free devices to provide electricity. Combining the idea of waste recycling and NG, an NG using waste cigarette filter is a promising device to solve environmental problems and generates green energy to solve energy shortage problem.

Among many NGs developed until now, triboelectric nanogenerators (TENGs) can be a useful power source for to IoT device due to its stability, reliability, and energy efficiency. TENG is an emerging sustainable clean energy collecting technology. The working mechanism of TENG is based on triboelectric charging and electrostatic induction. TENGs show great energy collecting characteristics. Moreover, TENGs are also suitable as self-powered active sensors, and thus have many applications. The biomedical application of TENGs is considered to be very safe since the electric currents produced by TENGs are within microampere range, which is not harmful to humans. Compared to other energy harvesting devices such as piezoelectric, pyroelectric and thermoelectric, TENGs can generate appreciable voltages owing to their ultralow capacitance. To date, various types of materials and polymers have been used as electrode materials to fabricate TENG devices and harvest energy from various sources such as water flows, human motions, sound, magnetic field-induced motions, wind, and mechanical vibrations. Among them, TENGs fabricated from waste materials are of special importance owing to the trash-to-energy conversion properties. This type of TENG plays a significant role in environmental treatment and energy harvesting.

Recently, various types of waste material-based TENG devices possessing interesting triboelectric energy-harvesting properties have been developed. For instance, Khandelwal et al. fabricated waste plastic material-based TENG, which exhibited good triboelectric energy-harvesting performance by generating an electrical output voltage of 16 V and current of 0.18 μA. They also used edible materials such as layer, rice sheets, and edible silver leaf-based TENG, which displayed an electrical output voltage of 23 V and current of 0.32 μA. Natural rose petal waste material was utilized to develop a TENG device that generated an output voltage of 31 V and output current of 0.8. An aloe vera plant-based TENG was also fabricated and was found to exhibit piezoelectric energy-harvesting properties by producing a current of 0.11 μA and output voltage of 32 V. TENG device developed from waste materials, such as fibroins, silk, and egg, showed good triboelectric property by harvesting an output current of 0.6 μA. Kitchen waste egg shell (collagen), waste garlic skin, onion skin, and almond peel-based TENG device has also been fabricated; this device was found to generate approximately 35 V output voltage and 0.5 μA output current. These findings confirm the potential applicability of waste materials based on the development of TENGs for the generation of renewable and green energy, which is very important to overcome energy shortages. Natural polymers have advantages, such as biodegradability, eco-friendliness, abundance, low cost, and renewability. Therefore, suitable natural polymer materials should be selected for the development of TENG devices with outstanding triboelectric properties.

### SUMMARY OF THE INVENTION

The objective of the present invention is to provide a triboelectric nanogenerator comprising two substrate, two aluminum electrode layers laid between said substrates, a positive triboelectric fiber layer made of multiple cigarette filters mixed with a conductive material laid between said aluminum layers, a negative triboelectric plastic layer laid between one of said aluminum electrode layers and said positive triboelectric fiber layer, multiple supportive layers installed between said two substrates, and two conductive wires connecting to said positive triboelectric fiber layer and said negative triboelectric plastic layer respectively,

Wherein, the thickness of said positive triboelectric fiber layer is between 100 to 800 micron.

Wherein, said cigarette filters comprise cellulose acetate, and said conductive material of said positive triboelectric fiber layer is made of a material selected from at least one of carbon nanotubes, grapheme, metal powders, metal fibers, carbon fibers, and metal flakes.

Wherein, said negative triboelectric plastic layer is made of a material selected from at least one of polypropylene, polyvinyl chloride, polyethylene terephthalate, and polytetrafluoroethylene.

Wherein, the gap between said two substrates is not greater than 2 millimeter.

Wherein, said supportive layers include sponges.

Present invention also provides a method of manufacturing a triboelectric nanogenerator comprising steps of: collecting and processing multiple cigarette filters as a positive triboelectric fiber layer, wherein said positive triboelectric fiber layer comprises said cigarette filters mixed with conductive materials; collecting a plastic sheet as a negative triboelectric plastic layer; laying two electrode layers on the outer part of said positive triboelectric fiber layer and said negative triboelectric plastic layer respectively; laying two substrates on the outer part of said two aluminum electrode layers respectively; installing multiple supportive layers vertically between said two substrates; and connecting two conductive wires to said positive triboelectric fiber layer and said negative triboelectric plastic layer respectively.

Wherein, the processing of said cigarette filters further including steps of: the tipping paper of said cigarette filters are peeled off; said cigarette filters are washed with water; said cigarette filters are washed with alcohol; said cigarette filters are dried at 60 degree Celsius for 4 hours; and said cigarette filters are blended with a conductive material by at least one of the process of papermaking, hydroentangling, needle punching process, and thermal bonding, wherein said conductive material is made of a material selected from at least one of carbon nanotubes, graphene, metal powders, metal fibers, carbon fibers, and metal flakes.

Wherein, said negative triboelectric plastic layer includes polypropylene, polyvinyl chloride, polyethylene terephthalate or polytetrafluoroethylene.

Wherein, the gap between said two substrates is not greater than 2 millimeter.

The present invention provides a novel triboelectric nanogenerator that is the first of its kind to utilize disposed cigarette fibers as the raw material of TENGs. Furthermore, the present invention is stable, economical, convenient, and easy to manufacture, generating electric voltage and electric current from disposed cigarette filters and plastic waste. The present invention also shows outstanding energy collecting performance that charge low-power electronics and have great potential to solve the energy shortage problems and maximize the usage of waste.

### BRIEF DESCRIPTION OF THE DRAWINGS

FIG. 1 is an exploded perspective view of a cigarette filter triboelectric nanogenerator in accordance with the present invention;

FIG. 2a is a lower magnification SEM image of a positive triboelectric fiber layer of the cigarette filter triboelectric nanogenerator in FIG. 1;

FIG. 2b is a higher magnification SEM image of a positive triboelectric fiber layer of the cigarette filter triboelectric nanogenerator in FIG. 1;

FIG. 2c is an SEM image of a cross section of a positive triboelectric fiber layer of the cigarette filter triboelectric nanogenerator in FIG. 1;

FIG. 3 is a schematic diagram of a working mechanism of the cigarette filter triboelectric nanogenerator in FIG. 1;

FIG. 4a shows diagrams of output voltage with respect to time of cigarette filter triboelectric nanogenerators in accordance with the present invention with different negative triboelectric plastic layers;

FIG. 4b shows diagrams of electric current with respect to time of cigarette filter triboelectric nanogenerators in accordance with the present invention with different negative triboelectric plastic layers;

FIG. 4c shows diagrams of output voltage and electric current with respect to external load resistance of cigarette filter triboelectric nanogenerators in accordance with the present invention with different negative triboelectric plastic layers;

FIG. 4d shows diagrams of power density with respect to external load resistance of cigarette filter triboelectric nanogenerators in accordance with the present invention with different negative triboelectric plastic layers;

FIG. 5a shows diagrams of stability tests of the cigarette filter triboelectric nanogenerator in FIG. 1;

FIG. 5b shows diagrams of the electrical performances of the cigarette filter triboelectric nanogenerator in FIG. 1 under various forces;

FIG. 5c shows diagrams of the output voltage of the cigarette filter triboelectric nanogenerator in FIG. 1 with various areas;

FIG. 5d shows diagrams of the electric current of the cigarette filter triboelectric nanogenerator in FIG. 1 with various areas;

FIG. 6a shows the cigarette filter triboelectric nanogenerator in FIG. 1 lighting up 44 LEDs;

FIG. 6b shows diagrams showing the cigarette filter triboelectric nanogenerator FIG. 1 charging four different capacitors;

FIG. 6c shows diagrams showing the charge-discharge behavior of the cigarette filter triboelectric nanogenerator in FIG. 1;

FIG. 6d shows the cigarette filter triboelectric nanogenerator in FIG. 1 powering up an LCD portable timer clock;

FIG. 7a shows diagrams showing the cigarette filter triboelectric nanogenerator in FIG. 1 on a centrifuge machine;

FIG. 7b shows diagrams of the electrical performances of the cigarette filter triboelectric nanogenerator in FIG. 1;

FIG. 7c shows close-up diagrams of the diagrams of FIG. 7b at around 2000 rpm;

FIG. 7d shows diagrams of the cigarette filter triboelectric nanogenerator in FIG. 1 connected to a bridge rectifier circuit;

FIG. 7e shows diagrams of the charge-discharge and stability curves of the cigarette filter triboelectric nanogenerator in FIG. 1;

FIG. 7f shows the cigarette filter triboelectric nanogenerator in FIG. 1 powering up an LCD portable timer clock through a bridge rectifier and 10 μF capacitor.

### DETAILED DESCRIPTION OF THE PREFERRED EMBODIMENTS

Other objects, advantages and novel features of the invention will become more apparent from the following detailed description when taken in conjunction with the accompanying drawings.

In the specification of the application, the term a, one, one kind or the does not express single but also can express plural. Generally, the term comprise and include indicate to have the components and steps being listed, and the list is not exclusive. The method or device may have another steps or components.

It is understandable that the term “nanogenerator” of this invention signifies the conductive materials comprising processed cigarette filters blended with conductive nanomaterials by papermaking process, hydroentangling process, needle punching process, or thermal bonding process, wherein the conductive nanomaterials include carbon nanotubes, graphene, metal powders, metal fibers, carbon fibers, or metal flakes.

It is understandable that the “negative triboelectric plastic layer” of this invention is a common plastic sheet. The ingredients of the plastic sheet include, but not limited to polypropylene, polyvinyl chloride, polyethylene terephthalate or polytetrafluoroethylene. Also, it is understandable that the “supportive layers” signify materials with elasticity including, but not limited to sponges.

### First Embodiment: Preparation of the Materials of the Nanogenerator

The cigarette filter triboelectric nanogenerator (CF-TENG) comprises a positive material, a negative material, and two electrodes. The positive material is made of multiple waste cigarette filters composed of cellulose acetate, the negative material is made of recycled plastic sheets, and the electrodes are made of recycled aluminum foils.

Polypropylene folder, polyvinyl chloride, polyethylene terephthalate, polytetrafluoroethylene are used as a release film for the preparation of the composites. Cigarette filters (CF) are collected from roadside garbage bins. Aluminum foils are collected from the laboratory garbage bin. Prior to use, all plastic wastes are thoroughly washed with water and then are dried at 40° C. for two hours. The tipping papers on the CF are peeled off by hand, and the filters are cleaned three times with ethanol and dried at 60° C. for four hours. Subsequently, the processed CF is blended with conductive nanomaterials, wherein the conductive nanomaterials include carbon nanotubes, graphene, metal powders, metal fibers, carbon fibers, or metal flakes and forms a positive triboelectric fiber layer. The blending methods include papermaking process, hydroentangling process, needle punching process, thermal bonding process or any other nonwovens manufacturing process. The said processes homogenize the CF and the conductive nanomaterials. The thickness of the positive triboelectric fiber layer is between 100 to 800 micron. Recycled Al foil lacks long-term stability in triboelectric nanogenerator (TENG) devices that undergo wear/tear effects when in direct contact with the opposite material. To solve this problem, this embodiment utilize CF composed of cellulose acetate as a positive material, recycled plastic waste as the negative material, and supporting substrates for the CF-TENG. Multiple supportive layers may be mounted between two substrates to provide a space for deformation.

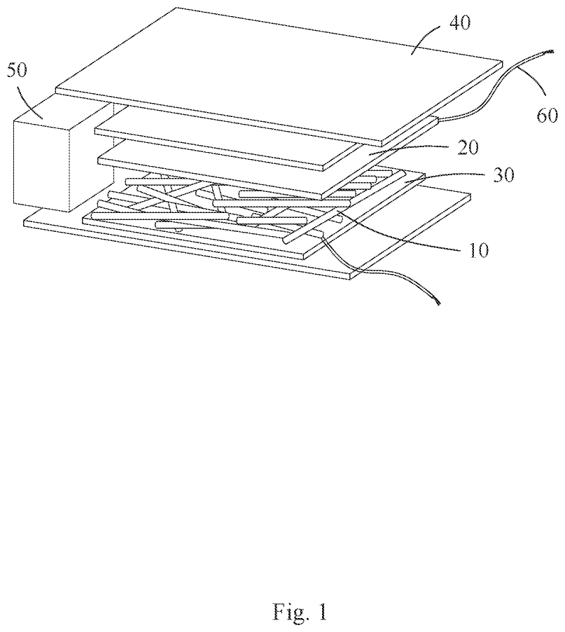

With reference to FIG. 1, a positive triboelectric fiber layer 10 is made of multiple cigarette filters mixed with a conductive material. A recycled plastic sheet is used as a negative triboelectric plastic layer 20, recycled aluminum foils are used as top and bottom aluminum electrodes 30, two substrates 40 are laid on the outer part of the aluminum electrodes 30, multiple supportive layers 50 made of sponges are mounted between two substrates, and two conductive wires 60 connecting to said positive triboelectric fiber layer and said negative triboelectric plastic layer respectively. In this embodiment, the CF-TEN device with contact-separation mode of various dimensions (2.5×2.5 cm², 3.5×3.5 cm², 5×5 cm², and 7×7 cm²) were prepared to determine the effect of TENG area on the triboelectric property. The triboelectric, layer components were assembled with a separation distance of 2 mm using a recycled kitchen sponge as a spacer.

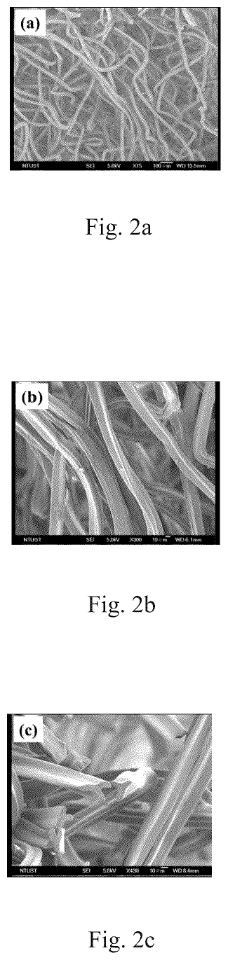

The functional groups in the waste materials are investigated using FTIR. FTIR scans are performed over the range of 1500-550 cm⁻¹ at a resolution of 4 cm⁻¹. The surface morphologies of the waste materials are characterized using field-emission scanning electron microscopy. A universal tester is applied to apply vertical compression to the TENG device. The electrical output responses of CF-TENG were recorded using a Keithley source meter unit. To evaluate the triboelectric property, the fabricated CF-TENG device was placed under compression, where the force can be applied using a load cell at a fixed frequency of 0.15 Hz. The electrical output responses were collected and evaluated using a computer. The FESEM surface morphology images of the CF at different magnifications are shown in FIG. 2a and FIG. 2b. Based on the results, the CF is composed of fibers with an average diameter of 24±30 micron. The FESEM cross-sectional image in FIG. 2c confirms that the CF is composed of fibers.

### Second Embodiment: Working Mechanism of the Nanogenerators and Performances of the Nanogenerators With Different Materials

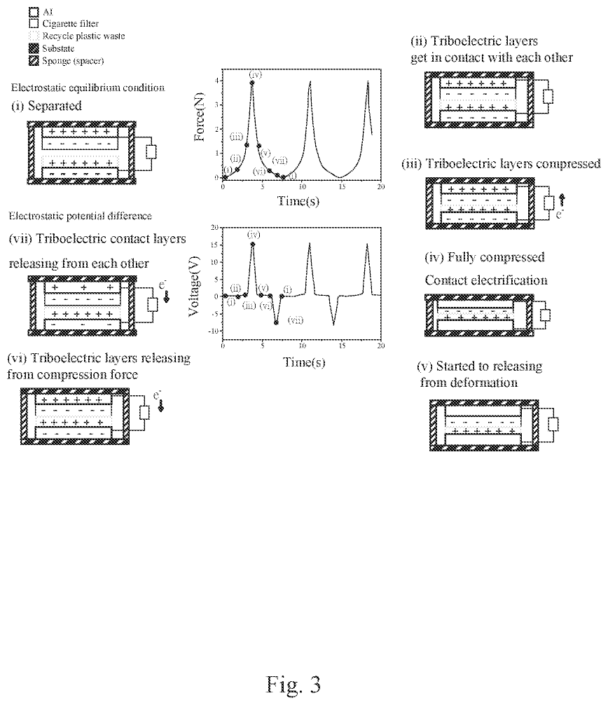

The working mechanism of the CF-TENG device was proposed, and a detailed explanation of the phenomena with respect to the applied force versus voltage generated was provided. Previously, different researchers reported the working mechanism of the contact-separation mode TENG, and how the force and output voltages were obtained but were not explained in detail. Further, no study discussed the flow of current from positive to negative with respect to the applied force. Herein, the force versus voltage working mechanism of the developed contact-separation mode CF-TENG device based on electrostatic induction and the triboelectric effect is demonstrated. Further, how the current flows from positive to negative upon the application of a force is revealed for the first time and is depicted in FIG. 3. When two oppositely-charged tribosurfaces come into physical contact with each other with the application of an external force, the corresponding electrostatic charges are produced on the surfaces. When the external force is removed, an electrostatic potential difference is generated between the two tribosurfaces across the external circuit, which in turn induces an electrical output. In this study, CF functions as a positive triboelectric surface owing to its high tendency to lose electrons, thereby a positive charge is generated. In contrast, recyclable plastic wastes are applied as negative triboelectric surfaces owing to their propensity to gain electrons and induce negative charges. The overall charge production process can be classified into seven steps. With reference to FIG. 3, in step one (i), the triboelectric layers are separated from each other and no force is applied; thus, there is no electrical charge flow. In step two (ii), the force is applied but this force only moves the spacer (sponge). Therefore, there is no charge generation. In steps three to four (iii) to (iv), the force is applied on both triboelectric layers, which are in contact with each other to produce a potential difference, thereby a positive electrical signal is generated. The maximum charge is generated at the maximum applied force, as shown in (iv). From steps four to five (iv) to (v), the external applied force starts to be released, and the charge flow decreases and reaches zero. In step six, as shown in (vi), the force starts to be released from the spacer and is finally released at the seventh step, as shown in (vii), thereby generating a reverse negative output potential; the highest negative voltage is produced in step seven (vii). Finally, after removal of all applied external forces, the triboelectric layers separate from each other and become neutral, returning the negative output potential to zero at the equilibrium state.

Therefore, when two oppositely-charged tribosurfaces come into physical contact with each other with the application of an external force, the corresponding electrostatic charges are produced on the surfaces. When the external force is removed, an electrostatic potential difference is generated between the two tribosurfaces across the external circuit, which in turn induces an electrical output. In this study, CF functions as a positive triboelectric surface owing to its high tendency to lose electrons, thereby generating a positive charge. In contrast, recyclable plastic wastes are used as negative triboelectric surfaces owing to their propensity to gain electrons and induce negative charges.

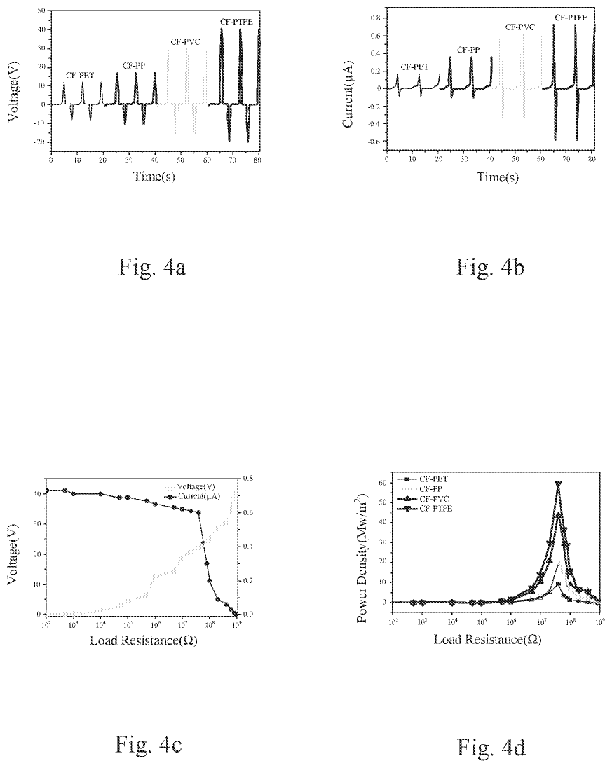

In this embodiment, the electrical performances of the CF-TENG device with various negative triboelectric plastic layers (PET, PP, PVC, and PTFE) were examined under an external compression force of 10 N. FIG. 4a and FIG. 4b illustrate the obtained results. Based on the results, the CF-PTFE TENG device exhibits the highest electrical performance, followed by PVC, PP, and PET. The high electrical performance of the CF-PTFE TENG device can be ascribed to the higher negative charge of PTFE than that of PET, PP, and PVC. This result confirms that PTFE is an ideal negative triboelectric material for use with CF.

Practically, the output power of the NG effectively depends on the external load. To determine the amount of power generated by the developed CF-TENG the devices were attached to electrical resistors under various external loads. Thereafter, the electrical outputs across the resistors are analyzed and further utilized to assess the power density. As depicted in FIG. 4c, the output voltage of the CF-TENG increases with increasing load resistance. In contrast, the current of the CF-PTFE TENG exhibits an inverse relationship with that of the load resistance these properties meet with the Ohm rule. The effect of load resistance on the electrical performance of the other recycled plastic wastes exhibits a similar trend to that of CF-PTFE TENG. Subsequently, the output power density values of the CF-TENG with respect to the load resistances are assessed using the formula, P=I2R/A and the results are presented in FIG. 4d.

Based on the result, the power density of the TENG devices is found to be less under open-circuit or short-circuit conditions. However, after increasing the load resistance, the power density is approximately ˜62.3, 40.23, 21.73, and 9.78 mW·m⁻² for CF-PTFE, CF-PVC, CF-PP, and CF-PET, respectively at load resistance of 40 MΩ, applied force of 10 N, and compression frequency of 0.1 Hz. Among the CF-TENG devices, CF-PTFE TENG and CF-PET TENG exhibits the highest and lowest power densities, respectively. A load resistance of 40 MΩ is found to be the optimized load-matching resistance for practical and real-time applications.

### Third Embodiment: CF-PTFE TENG Stability Test

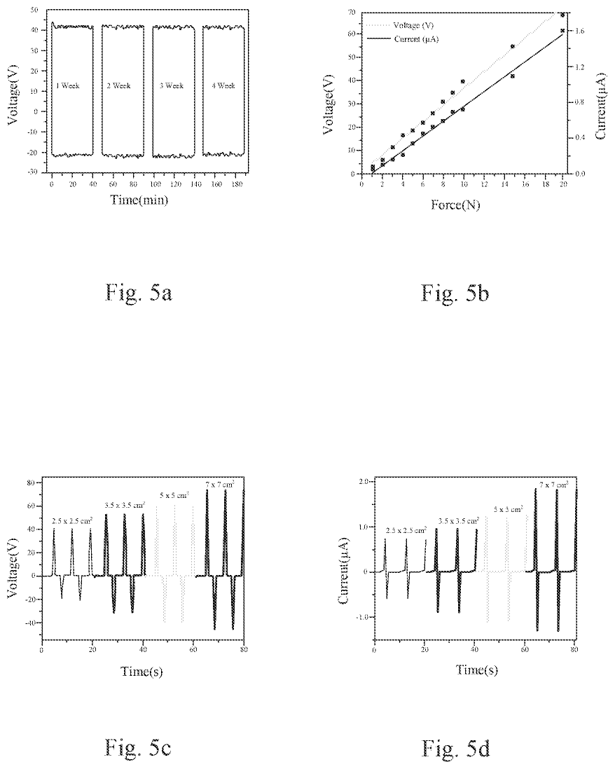

The cyclic stability of the fabricated CF-PTFE TENG device is evaluated for 3000 cycles under continuous operation with force of 10 N. Based on FIG. 5a, the developed TENG device presents outstanding cyclic stability. Further, even after 3000 cycles, no electrical performance change occurs, which indicates that the TENG can be utilized in real application. The long-term stability of the developed device is also investigated for up to four weeks (one month). Based on the results in FIG. 5a, the fabricated CF-PTFE TENG has excellent long-term stability. FIG. 5b shows the output voltage and current profiles of the CF-PTFE TENG device under various compression forces. The obtained results clearly reveal that the voltage and current of the device gradually increased from 5 V and 0.16 μA to 70 V and 1.6 μA, respectively, when the force is increased from 1 N to 20 N. The findings indicate an increase in output electrical performance with an increase in the applied force, with the highest performance obtained at 20 N. This gradual enhancement is mainly ascribed to the appreciable surface contact area of the CF-PTFE TENG device at a higher applied force. FIG. 5(c) shows the effect of the TENG area on the electrical properties of the TENG. The output voltage increases with an increase in the area of the TENG under an applied compression force of 10 N and frequency of 0.1 Hz. Further, the highest output voltage of 74.3 V is obtained by the TENG with the highest area of 7×7 cm². FIG. 5(d) indicates that the electrical current significantly increased with increasing area of the CF-PTFE TENG, and the highest current of 1.85 μA is obtained by the TENG with the highest area. The enhanced electrical performance with the TENG area is due to the generation of a greater number of charges at higher areas.

CF-TENG stably worked under continuous operation with force of 10 N even after 3000 cycles with no electrical performance change occurred, which indicates that CF-TENG could be utilized in real application with great stability.

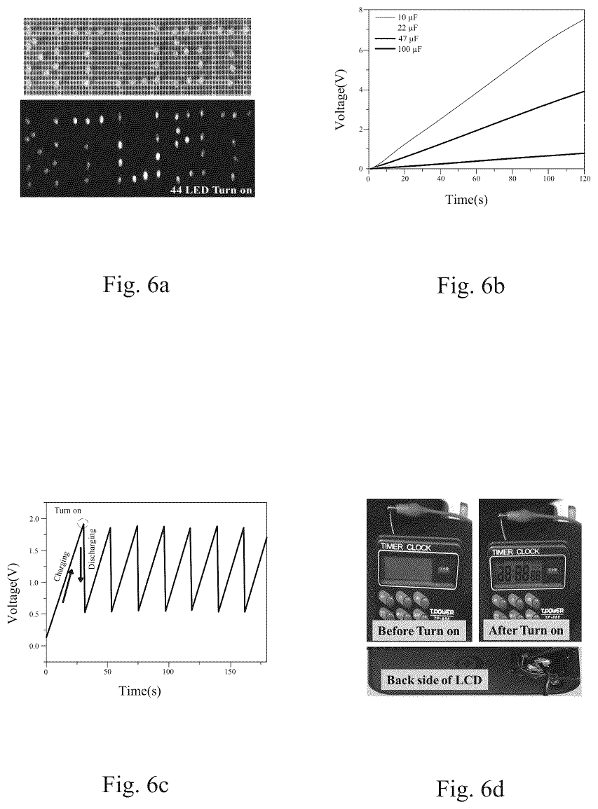

In this embodiment, a CF-PTFE TENG device with dimensions of 5×5 cm² is used. FIG. 6a shows that 44 LEDs are successfully turned on by the developed CF-PTFE TENG under hand tapping force (approximately 10 N) within 120 seconds. FIG. 6b shows that the four different capacitors (10, 22, 47, and 100 μF) were charged by the energy generated by CF-PTFE TENG. The capacitor charging curve (FIG. 6b) also shows that a capacitor of 10 μF can be charged to 7.8 V within 120 seconds, and capacitors of 100 μF can be charged to 1.3 V under the same experimental conditions by using the full wave rectifier. The amount of energy harvested and stored by the developed device is calculated according to the formula

$${U}_{e} = \frac{1}{2} C {V}^{2}$$

where, C is the capacitor capacitance, Ue is the stored energy, and V is the generated output voltage. Approximately 304 μJ of energy can be stored using a 10 μF capacitor. Such finding highlights the advantages of the high performance of the fabricated device based on waste materials. FIG. 6c shows the charging and discharging curves of the 10 μF capacitor, which indicates that the capacitor can be charged to an output voltage within a short time (29 seconds). Further, excellent cyclic charging discharging stability is found for the seven studied cycles. The accumulated voltage (1.8 V) in the capacitor was applied to display the timer clock LCD. Based on FIG. 6d, the timer an be displayed for 1 seconds after 131 taps. These findings confirm that the CF-PTFE TENG of this embodiment possesses promising applicability in the daily charging of microelectronic devices.

### Fourth Embodiment: CF-PTFE TENG Applications

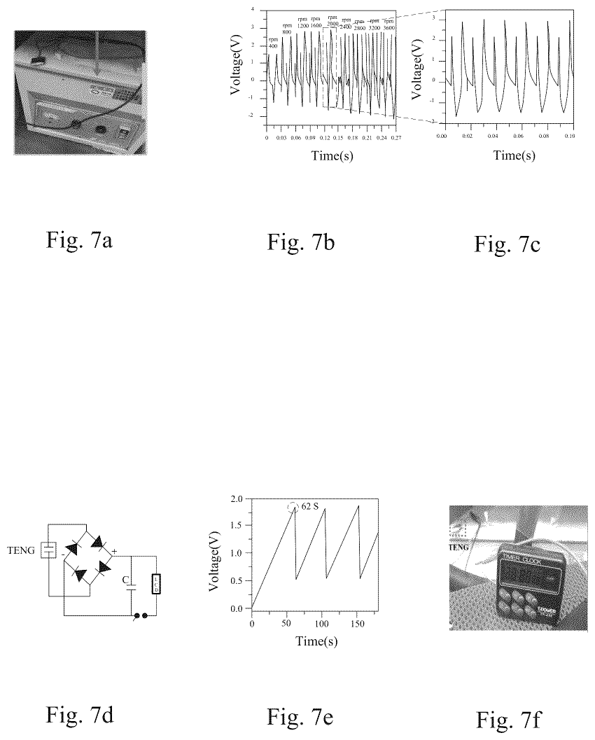

Various types of machinery and equipment are employed daily. During their operation, these machineries generate waste mechanical energy, such as vibration energy. This waste energy can be harvested and utilized with the aid of nanogenerator devices, and is considered green, renewable, and eco-friendly. Therefore, the fabricated CF-PTFE TENG device is applied in this embodiment to harvest energy from the waste vibration using a laboratory centrifuge. Harvesting these types of waste energy is highly beneficial for global energy demand. FIG. 7a shows a photographic image of the centrifuge and the CF-PTFE TENG device on the centrifuge. FIG. 7b depicts the electrical outputs obtained from the waste vibrations generated by the centrifuge, which was operated at various rotational speeds (from 400 rpm to 3600 rpm). The findings revealed that a maximum output voltage of 3.1 V is harvested from the waste vibration of the centrifuge at 2000 rpm. Based on the results, two types of peaks (main peaks and intermediate peaks) are produced, and the intermediate peak signal increases with increasing rotational speed, and becomes equal to the main peak at 2800 rpm. This result is due to an increase in the frequency of vibration. Centrifuge vibrations reduce the time interval between two power-generation peaks. When the rpm reaches the critical speed, the interval time disappears, and the centrifuge machine rotates continuously. FIG. 7c shows the maximized view of the output voltage obtained at 2000 rpm. FIG. 7d shows a schematic of a bridge rectifier, which is used to convert the AC output signal to a DC signal. A 10 μF capacitor is connected to the rectifier bridge to store the output voltage generated from the waste vibration energy generated by the centrifuge at a frequency of 60 Hz. FIG. 7e shows the charge-discharge curves of the 10 μF capacitor using the waste vibration energy harvested by the TENG. According to the result, approximately 1.8 V of voltage can be harvested from the waste vibration energy within 62 seconds. Furthermore, the device displayed outstanding charging discharging stability for the three investigated cycles. An accumulated voltage of 1.8 V in the capacitor is applied to turn on the LCD of the portable timer clock. FIG. 7f shows that the timer can be displayed for 1 second by the harvested energy. These results indicate the potential practical applicability of the fabricated CF-PTFE TENG device for harvesting energy from waste vibration energy, which can enable users to charge their portable electronic devices while performing daily routine activities. An electrical output of approximately 4 V can be harvested by the developed TENG under compression using a football, and an output voltage of 1.5 V from water flow. An output voltage of approximately 3 V can be generated by CF-PTFE TENG from the footstep (compression), and an average of 0.6 V can be harvested based on the vibration of the human throat during talking. Therefore, the fabricated CF-PTFE TENG device can play a crucial role in the use of renewable energy sources.

### Fifth Embodiment: Comparison of Electrical Performances of Various Waste Triboelectric Materials

The electrical performance of the developed CF-PTFE TENG of this embodiment is compared with that of the public literature. According to the results in Table 1, the embodiment of this invention exhibits better electrical output performance than other TENG devices. In addition, the fabrication method of this invention is easy, low-cost, and eco-friendly. Thus, waste CF is a potential candidate for use as a positively-charged triboelectric material.

TABLE 1
Comparison of electrical performances of various waste triboelectric materials

| | | | | Power | |
|---|---|---|---|---|---|
| | Type of | Voltage | Current | density | |
| Waste triboelectric materials | generators | (V) | (μA) | (mW/m²) | Ref. |
| PP and PE, cleaning sponge | TENG | 16.0 | 0.18 | 3.20 | (Khandelwal |
| | | | | | et al., 2018) |
| Laver (gim), rice sheets and | TENG | 23.0 | 0.31 | 0.02 | (Khandelwal |
| edible silver leaf | | | | | et al., 2019) |
| Chitin, cellulose, fibroins, | TENG | 55.0 | 0.61 | 21.60 | (Jiang |
| silk, rice paper, and egg white | | | | | et al., 2018) |
| Natural rose petal | TENG | 30.6 | 0.78 | 27.20 | (Chen |
| | | | | | et al., 2018) |
| Discarded cigarette filters | TENG | 42.8 | 0.86 | 63.24 | This work |

The embodiments of this invention exhibited superior electrical performances and demonstrated stable electrical features under various compressive forces. Moreover, the embodiments of this invention also exhibits stable cyclic charging and discharging performances, and the stability is crucial for practical real-time applications, and displays excellent waste vibration energy-harvesting properties. Thus, this invention paves way to use of waste material in energy-harvesting applications that is very interesting from environmental and energy generation perspectives.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A triboelectric nanogenerator comprising:
two substrate;
two aluminum electrode layers laid between said substrates;
a positive triboelectric fiber layer made of multiple cigarette filters mixed with a conductive material laid between said aluminum layers;
a negative triboelectric plastic layer laid between one of said aluminum electrode layers and said positive triboelectric fiber layer;
Multiple supportive layers installed between said two substrates; and
two conductive wires connecting to said positive triboelectric fiber layer and said negative triboelectric plastic layer respectively.

2. The triboelectric nanogenerator as claimed in claim 1, wherein the thickness of said positive triboelectric fiber layer is between 100 to 800 micron.

3. The triboelectric nanogenerator as claimed in claim 1, wherein said cigarette filters comprise cellulose acetate, and said conductive material of said positive triboelectric fiber layer is made of a material selected from at least one of carbon nanotubes, graphene, metal powders, metal fibers, carbon fibers, and metal flakes.

4. The triboelectric nanogenerator as claimed in claim 1, wherein said negative triboelectric plastic layer is made of a material selected from at least one of polypropylene, polyvinyl chloride, polyethylene terephthalate, and polytetrafluoroethylene.

5. The triboelectric nanogenerator as claimed in claim 1, wherein the gap between said two substrates is not greater than 2 millimeter.

6. The triboelectric nanogenerator as claimed in claim 1, wherein said supportive layers include sponges.

7. A method of manufacturing a triboelectric nanogenerator comprising steps of:
(a) collecting and processing multiple cigarette filters as a positive triboelectric fiber layer, wherein said positive triboelectric fiber layer comprises said cigarette filters mixed with conductive materials;
(b) collecting a plastic sheet as a negative triboelectric plastic layer;
(c) laying two electrode layers on the outer part of said positive triboelectric fiber layer and said negative triboelectric plastic layer respectively;
(d) laying two substrates on the outer part of said two aluminum electrode layers respectively;
(e) installing multiple supportive layers vertically between said two substrates; and
(d) connecting two conductive wires to said positive triboelectric fiber layer and said negative triboelectric plastic layer respectively.

8. The method of manufacturing a triboelectric nanogenerator as claimed in claim 7, wherein the processing of said cigarette filters further including steps of:
(a) the tipping paper of said cigarette filters are peeled off;
(b) said cigarette filters are washed with water;
(c) said cigarette filters are washed with alcohol;
(d) said cigarette filters are dried at 60 degree Celsius for 4 hours; and
(e) said cigarette filters are blended with a conductive material by at least one of the process of papermaking, hydroentangling, needle punching process, and thermal bonding, wherein said conductive material is made of a material selected from at least one of carbon nanotubes, graphene, metal powders, metal fibers, carbon fibers, and metal flakes.

9. The method of manufacturing a triboelectric nanogenerator as claimed in claim 7, wherein said negative triboelectric plastic layer is made of a material selected from at least one of polypropylene, polyvinyl chloride, polyethylene terephthalate, and polytetrafluoroethylene.

10. The method of manufacturing a triboelectric nanogenerator as claimed in claim 7, wherein the gap between said two substrates is not greater than 2 millimeter.
